(19) United States
(12) Patent Application Publication
(10) Pub. No.: US 2010/0128010 A1
(43) Pub. Date: May 27, 2010

(54) LIQUID CRYSTAL DISPLAY DEVICE AND METHOD FOR DRIVING THE SAME

(75) Inventors: Hiromi Katoh, Osaka (JP); Christopher Brown, Oxford (GB)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, OSAKA-SHI OSAKA (JP)

(21) Appl. No.: 12/595,892

(22) PCT Filed: Jun. 3, 2008
(86) PCT No.: PCT/JP2008/060225

§ 371 Date: Oct. 14, 2009

(30) Foreign Application Priority Data
Jul. 13, 2007 (JP) 2007-185029

(51) Int. Cl. G09G 3/36; G09G 5/00

(52) U.S. Cl. 345/207; 345/102

(57) ABSTRACT

A liquid crystal display device (1) includes: a liquid crystal display panel (10) in which a liquid crystal layer (13) is provided between an active matrix substrate (11) and a counter substrate (12); and a backlight (20) which emits light toward the liquid crystal display panel (10). A peripheral region (R2) which is on a periphery of an image display region (R1) includes light sensors [16 (16a and 16b)] for detecting an external brightness of the liquid crystal display device (1). Light emitted from the backlight (20) has a transmittance of not more than a transmittance obtained during black display in the peripheral region (R2) in which the light sensors are provided, while the light sensors are detecting an external brightness of the liquid crystal display device (1). This allows a realization of a liquid crystal display device including light sensors which are less affected by stray light and are capable of detecting external light with higher accuracy.

### TECHNICAL FIELD

The present invention relates to a liquid crystal display device, particularly to a liquid crystal display device including a display panel in which a light sensor for detecting external light is provided.

### BACKGROUND ART

A flat panel display device as typified by a liquid crystal display device has features such as flatness, lightweight, and low power consumption. Further, a technological development is advancing in such a flat panel display device so as to improve a display performance such as causing the display flat panel device to be colored and highly fine, and to respond to a moving picture. For this reason, the display device is currently incorporated into a variety of electronic devices such as a mobile phone, a PDA, a DVD player, a mobile game device, a laptop PC, a PC monitor, and a TV.

Against this backdrop, in order to realize better visibility and lower power consumption in a display device, a display system has been suggested which has an automatic light control function for automatically controlling a luminance of a display device in accordance with a brightness of external light. For example, each of Patent Literature 1 and Non Patent Literatures 1 and 2 discloses a display device including a light sensor provided in a peripheral region of the display device. Furthermore, Patent Literature 2 discloses a technique in which a light sensor, TFT elements, and the like are concurrently formed on the substrate.

Such a display device including a light sensor allows a realization of both good visibility and low power consumption even in a case where there occurs a change in brightness of an environment in which the display device is used. Therefore, such a display device has a number of occasions to be taken outside for use. Such a display device is useful particularly for a mobile device which needs to be battery-powered (e.g. a mobile phone, a PDA, a mobile game device, and the like).

### Citation List

Patent Literature 1

Japanese Patent Application Publication, Tokukai, No. 2002-62856 A (Publication Date: Feb. 28, 2002)

Patent Literature 2

International Patent Application Publication No. WO2006/118044 A1 (Publication Date: Nov. 9, 2006)

Non Patent Literature 1

S. Koide et al., “LTPS Ambient Light Sensor with Temperature Compensation”, IDW06 pp. 689-690, December 2006

Non Patent Literature 2

F. Matsuki et al., “P-198L: Late-News Poster: Integrated Ambient Light Sensor in LTPS AMLCDs”, SID 07 DIGEST pp. 290-293, May 2007

### SUMMARY OF INVENTION

In a technical field of a light sensor as mentioned above, a technique has been suggested in which: two light sensors are provided for at least temperature compensation; one of the two light sensors is used as a detection sensor for detecting external light; and the other of the two light sensors is used as a correction sensor (hereinafter, referred to as a reference sensor) which carries out a correction while blocking external light (refer to Non Patent Literature 1). This technique allows a compensation for a light sensor's detection property which varies depending on an external factor such as a temperature, and it is therefore possible to realize a sensor with higher accuracy.

However, even in the case where the two light sensors are used, there occurs a problem that the detection light sensor of the two light sensors causes a deterioration in its detection accuracy because the detection sensor also detects stray light due to a backlight. The following describes this point.

FIG. 9 is a partial cross-sectional view of a conventional liquid crystal display device 100 provided with light sensors. FIG. 9 illustrates a peripheral region (frame region) of the liquid crystal display device 100 which peripheral region is on the periphery of an image display region. The liquid crystal display device 100 includes a liquid crystal display panel 110 and a backlight 120 which is provided on a rear side of the liquid crystal display panel 110 (see FIG. 9).

The liquid crystal display panel 110 is arranged such that a liquid crystal layer 113 is filled between an active matrix substrate 111 on which TFT elements (not illustrated) are provided in a matrix pattern and a counter substrate 112 on which a counter electrode (not illustrated) is provided. A rear side polarizing plate 114 and a front side polarizing plate 115 are provided outside the active matrix substrate 111 and the counter substrate 112, respectively.

It should be noted here that FIG. 9 mainly illustrates a part of the peripheral region of the liquid crystal display panel 110, and this region is a non-display region. For this reason, a black matrix 118 is provided on a surface of the counter substrate 112 which surface faces the liquid crystal layer 113.

The liquid crystal display panel 110 is provided with two light sensors 116a and 116b so as to detect a brightness of an environment in which the liquid crystal display device 100 is used. The light sensors 116a and 116b are provided above the active matrix substrate 111, via respective light blocking sections 117 which are provided on the substrate (see FIG. 9).

These two light sensors are: (i) the light sensor 116a serving as a detection light sensor and (ii) the light sensor 116b serving as a reference light sensor. The black matrix 118 has an opening 118a via which external light enters and which faces the light sensor 116. This is because the detection light sensor 116a is provided so as to detect a brightness of the environment in which the liquid crystal display device 100 is used. On the other hand, a region above the light sensor 116b is light-blocked by the black matrix 118 since the light sensor 116b serves as a correction sensor for at least carrying out a temperature compensation.

I-V characteristics of diodes constituting the respective light sensors 116a and 116b were measured in a dark place. (a) and (b) of FIG. 10 illustrate the results thus measured. (a) of FIG. 10 is the result for the reference light sensor 116b, and (b) of FIG. 10 is the result for the detection light sensor 116a. Each of the drawings illustrates: I-V characteristic (Best) which is an ideal one in a dark place; I-V characteristic (BL_on) obtained while a backlight is being turned on; I-V characteristic (BL_off) obtained while the backlight is being turned off; and I-V characteristic (3 Lux) obtained under an environment in which a brightness of 3 lux is kept (illustrated only in (b) of FIG. 10).

As for the reference light sensor 116b, I-V characteristics obtained (i) while the backlight is being turned on and (ii) while the backlight is being turned off are substantially identical to the I-V characteristic which is the ideal one in a dark place (see (a) of FIG. 10). However, as for the detection light sensor 116a, I-V characteristic obtained while the backlight is being turned on is similar to I-V characteristic obtained under the environment in which the brightness of 3 lux is kept (see (b) of FIG. 10). This means that the light sensor incorrectly detects, in a dark place whose brightness is supposed to be 0 lux, a brightness of 3 lux.

This seems to be because: while the backlight 120 is being turned on, light emitted from the backlight is reflected from the front side polarizing plate 115 and the light thus reflected becomes stray light, so that the stray light is detected by the light sensor 116a (see A1 of FIG. 9).

While the light sensor 116a is thus detecting such stray light due to light emitted from the backlight 120, there occurs a problem that it is impossible to accurately measure a brightness of the environment in which the liquid crystal display device 100 is used. As for the light sensor 116b, a problem of stray light does not occur since the black matrix 118, which is provided above the light sensor 116b, absorbs light emitted from the backlight (see A2 of FIG. 9).

A similar problem of stray light occurs not only in a case where two light sensors are provided but also in a case where a single light sensor is provided (i.e., in a case where no reference sensor is used), provided that a liquid crystal display device is arranged such that a light sensor is provided on an active matrix substrate and a backlight is directed from a rear side of the active matrix substrate.

The present invention has been made in view of the problems, and its object is to provide a liquid crystal display device including a light sensor which is less affected by stray light and is capable of detecting external light with higher accuracy.

In order to solve the problems, a liquid crystal display device according to the present invention includes: a liquid crystal display panel in which a liquid crystal layer is provided between an active matrix substrate and a counter substrate; a backlight which emits light toward the liquid crystal display panel, and a light sensor provided, in a peripheral region which is on a periphery of an image display region of the liquid crystal display panel, for detecting an external brightness of the liquid crystal display device, light emitted from the backlight having a transmittance of not more than a transmittance obtained during black display in the peripheral region in which the light sensor is provided, while the light sensor is detecting an external brightness of the liquid crystal display device.

According to the arrangement, light emitted from the backlight has a transmittance of not more than a transmittance obtained in the liquid crystal display during black display in the region of the liquid crystal display panel in which region the light sensor is provided. This causes light due to light emitted from the backlight not to be transmitted through the liquid crystal display panel. This allows a reduction in light which is emitted from the backlight, strays into the liquid crystal display panel, and is detected by the light sensor, such as light which is emitted from the backlight, reflected from an uppermost surface of the liquid crystal display panel, and enters a light receiving section of the light sensor (such light is referred to as stray light).

It is therefore possible to prevent the light sensor from improperly detecting stray light due to light emitted from the backlight. It follows that it is possible to solve the problem that the brightness of an external environment can not be accurately detected because the light sensor detects the stray light due to the light emitted from the backlight.

According to the present invention, it is possible to provide a liquid crystal display device including a light sensor which is less affected by stray light and is capable of detecting an external brightness with higher accuracy.

The liquid crystal display device of the present invention is preferably arranged such that: a display mode of the liquid crystal display panel is a normally black mode, the liquid crystal display device further comprising: a voltage application section for applying a voltage to at least one of the light sensor and the counter substrate so that no electric potential difference is generated between the light sensor and the counter substrate, while the light sensor is detecting the external brightness of the liquid crystal display device.

According to the arrangement, it is possible to cause a display state on the light sensor to be identical to a state during black display by causing no electric potential difference to be generated between the light sensor and the counter substrate. This allows a reduction in stray light reflected from the uppermost surface of the liquid crystal display panel.

Note that it is possible to adjust an electric potential of a part in which the light sensor is provided by, for example, providing a transparent conductive layer on the light sensor and applying a voltage to the transparent conductive layer. On the other hand, it is possible to adjust an electric potential of the counter substrate by, for example, applying a voltage to a counter electrode which is provided for causing an electric potential difference to be generated between the counter substrate and a pixel electrode provided on the active matrix substrate.

The liquid crystal display device of the present invention is preferably arranged such that: the counter substrate is provided with a counter electrode for causing an electric potential difference to be generated between the counter electrode and a pixel electrode provided on the active matrix substrate; the counter electrode is separated by a boundary between the image display region and the peripheral region; and the voltage application section applies a voltage to the counter electrode provided on the peripheral region.

According to the arrangement, application of a given voltage to the counter electrode by the voltage application section causes no electric potential difference to be generated between the light sensor and the counter substrate. Furthermore, the counter electrode separated by the boundary between the image display region and the peripheral region allows a free setting of a voltage of the counter electrode provided in the peripheral region, as described earlier. It is therefore possible to determine a voltage of the counter electrode provided in the peripheral region in accordance with an electric potential of the light sensor.

The liquid crystal display device of the present invention is preferably arranged such that: a display mode of the liquid crystal display panel is a normally black mode; the counter substrate is provided with a counter electrode for causing an electric potential difference to be generated between the counter electrode and a pixel electrode provided on the active matrix substrate; and no counter electrode is provided at least in a part of the peripheral region, which part faces a part where the light sensor is provided.

According to the arrangement, no counter electrode is provided in the part of the counter substrate which part faces the light sensor. Namely, according to the arrangement, the display mode of the liquid crystal display panel is the normally black mode, and no counter electrode is provided in the part in which the light sensor is provided. This causes an electric potential difference not to be generated between the light sensor and the counter substrate, irrespective of a voltage to be applied to the light sensor.

This allows a display state on the light sensor to be identical to a state during black display while the light sensor is detecting an external brightness, even if the voltage application section is not always provided. It is therefore possible to reduce stray light reflected from the uppermost surface of the liquid crystal display panel.

The liquid crystal display device of the present invention is preferably arranged such that: a display mode of the liquid crystal display panel is a normally white mode, the liquid crystal display device further comprising: a voltage application section for applying a voltage to at least one of the light sensor and the counter substrate so that an electric potential difference between the light sensor and the counter substrate is identical to an electric potential difference generated during black display in the image display region of the liquid crystal display panel, while the light sensor is detecting an external brightness of the liquid crystal display device.

According to the arrangement, it is possible to cause a display state on the light sensor to be identical to a state during black display by causing the voltage application section to apply a voltage to at least one of the light sensor and the counter substrate so as to cause an electric potential difference (an electric potential difference which is generated while a display of black gradation is carried out in a display panel) between the light sensor and the counter substrate to be identical to an electric potential difference generated during black display. This allows a reduction in stray light reflected from the uppermost surface of the liquid crystal display panel.

The liquid crystal display device of the present invention is preferably arranged such that: the counter substrate is provided with a counter electrode for causing an electric potential difference to be generated between the counter electrode and a pixel electrode provided on the active matrix substrate; the counter electrode is separated by a boundary between the image display region and the peripheral region; and the voltage application section applies a voltage to the counter electrode provided on the peripheral region.

According to the arrangement, application of a given voltage to the counter electrode by the voltage application section causes an electric potential difference between the light sensor and the counter substrate to be identical to an electric potential difference generated during black display in the liquid crystal display panel. Furthermore, the counter electrode separated by the boundary between the image display region and the peripheral region allows a free setting of a voltage of the counter electrode provided in the peripheral region, as described earlier. It is therefore possible to determine a voltage of the counter electrode provided in the peripheral region in accordance with an electric potential of the light sensor.

The liquid crystal display device of the present invention is preferably arranged to further include: a light blocking layer, provided in the peripheral region of the counter substrate, for blocking light emitted from the backlight, the light blocking layer having an opening, provided so as to face the light sensor, for detecting external light, a light blocking section being provided between the light sensor and the backlight, and the light blocking section having a surface whose area is larger than an area of the opening.

According to the arrangement, it is possible for the light blocking section which is provided under the light sensor (i.e., between the light sensor and the backlight) to block light emitted from the backlight. Further, the light blocking section has the surface whose area is larger than the area of the opening of the light blocking layer. This causes the light blocking layer to block light emitted from the backlight which light is leaked from outside the light blocking section. This allows a secure reduction in stray light due to light emitted from the backlight.

In order to solve the problems, a method for driving a liquid crystal display device in accordance with the present invention, the liquid crystal display device including: a liquid crystal display panel in which a liquid crystal layer is provided between an active matrix substrate and a counter substrate; a backlight which emits light toward the liquid crystal display panel, and a light sensor provided, in a peripheral region which is on a periphery of an image display region of the liquid crystal display panel, for detecting an external brightness of the liquid crystal display device, the method comprising the step of: setting an electric potential between the light sensor and the counter substrate so that light emitted from the backlight has a transmittance of not more than a transmittance obtained during black display in the peripheral region in which the light sensor is provided, while the light sensor is detecting an external brightness of the liquid crystal display device.

According to the method, setting of an electric potential difference between the light sensor and the counter substrate so that light emitted from the backlight has a transmittance of not more than a transmittance obtained in the liquid crystal display panel during black display in the region of the liquid crystal display panel in which region the light sensor is provided allows a reduction in light, such as light which is emitted from the backlight, reflected from the uppermost surface of the liquid crystal display panel, and enters the light receiving section of the light sensor.

It is therefore possible to prevent the light sensor from improperly detecting stray light due to light emitted from the backlight. It follows that it is possible to solve the problem that the brightness of an external environment can not be accurately detected because the light sensor detects the stray light due to the light emitted from the backlight.

The method for driving the liquid crystal display device of the present invention is preferably arranged such that: a display mode of the liquid crystal display panel is a normally black mode; and an electric potential of at least one of the light sensor and the counter substrate is set so that no electric potential difference is generated between the light sensor and the counter substrate, while the light sensor is detecting the external brightness of the liquid crystal display device.

According to the method, it is possible to cause a display state on the light sensor to be identical to a state during black display by causing no electric potential difference to be generated between the light sensor and the counter substrate. This allows a reduction in stray light due to light emitted from the backlight which stray light is reflected from the uppermost surface of the liquid crystal display panel.

The method for driving the liquid crystal display device of the present invention is preferably arranged such that: a display mode of the liquid crystal display panel is a normally white mode; and, an electric potential of at least one of the light sensor and the counter substrate is set so that an electric potential difference between the light sensor and the counter substrate is identical to an electric potential difference generated during black display in the image display region of the liquid crystal display panel, while the light sensor is detecting an external brightness of the liquid crystal display device.

According to the method, it is possible to cause a display state on the light sensor to be identical to a state during black display by setting an electric potential of at least one of the light sensor and the counter substrate so as to cause an electric potential difference (an electric potential difference which is generated while a display of black gradation is carried out in a display panel) between the light sensor and the counter substrate to be identical to an electric potential difference generated during black display. This allows a reduction in stray light due to light emitted from the backlight which stray light is reflected from the uppermost surface of the liquid crystal display panel.

A display system of the present invention includes: a liquid crystal display device as mentioned above; and a control section for controlling a display luminance of the liquid crystal display device in accordance with information on a brightness of external light, the brightness being detected by the light sensor provided in the liquid crystal display device.

According to the display system of the present invention, the control section controls a display luminance of a liquid crystal display device by adjusting a luminance of a backlight in accordance with information (sensor output) on a brightness of an external light, which brightness is detected by the light sensor. For example, it is possible to automatically adjust a luminance such that: a display luminance is increased under a bright environment such as outdoors; and a display luminance is decreased under a comparatively dark environment such as nighttime or indoors. This ultimately allows the arrangement to realize a reduction in power consumption and a life extension.

For a fuller understanding of the nature and advantages of the invention, reference should be made to the ensuing detailed description taken in conjunction with the accompanying drawings.

### BRIEF DESCRIPTION OF DRAWINGS

FIG. 1 is a partial cross-sectional view illustrating an arrangement of a liquid crystal display device according to a first embodiment of the present invention.

FIG. 2 is a perspective view illustrating an entire arrangement of the liquid crystal display device according to the first embodiment of the present invention.

FIG. 3 is a partial cross-sectional view of a liquid crystal display panel included in the liquid crystal display device of FIG. 1.

FIG. 4 is a partial cross-sectional view of an active matrix substrate included in the liquid crystal display device of FIG. 1, and illustrates a cross section structure of a part of a peripheral region in which part a light sensor is provided.

FIG. 5 is a block diagram illustrating how a voltage is applied to the light sensor provided in the liquid crystal display device of FIG. 1.

FIG. 6 illustrates an example of an electronic device which includes the liquid crystal display device of FIG. 1 and has an automatic light control function.

FIG. 7 illustrates another arrangement of the liquid crystal display device according to the first embodiment of the present invention.

FIG. 8 is a partial cross-sectional view illustrating an arrangement of a liquid crystal display device according to a second embodiment of the present invention.

FIG. 9 is a partial cross-sectional view of a conventional liquid crystal display device provided with light sensors.

FIG. 10

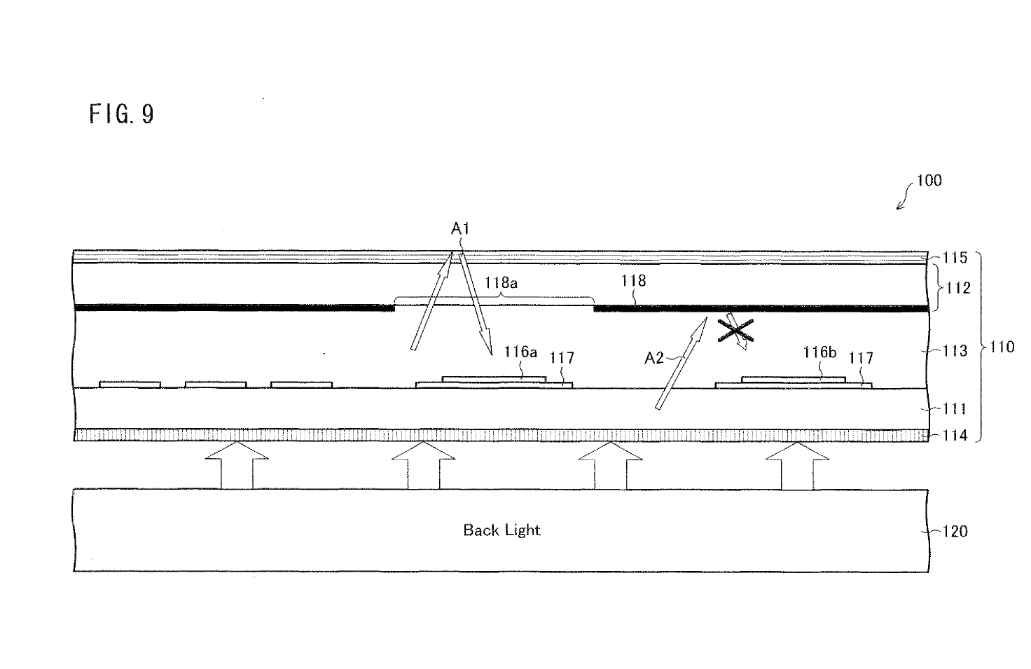

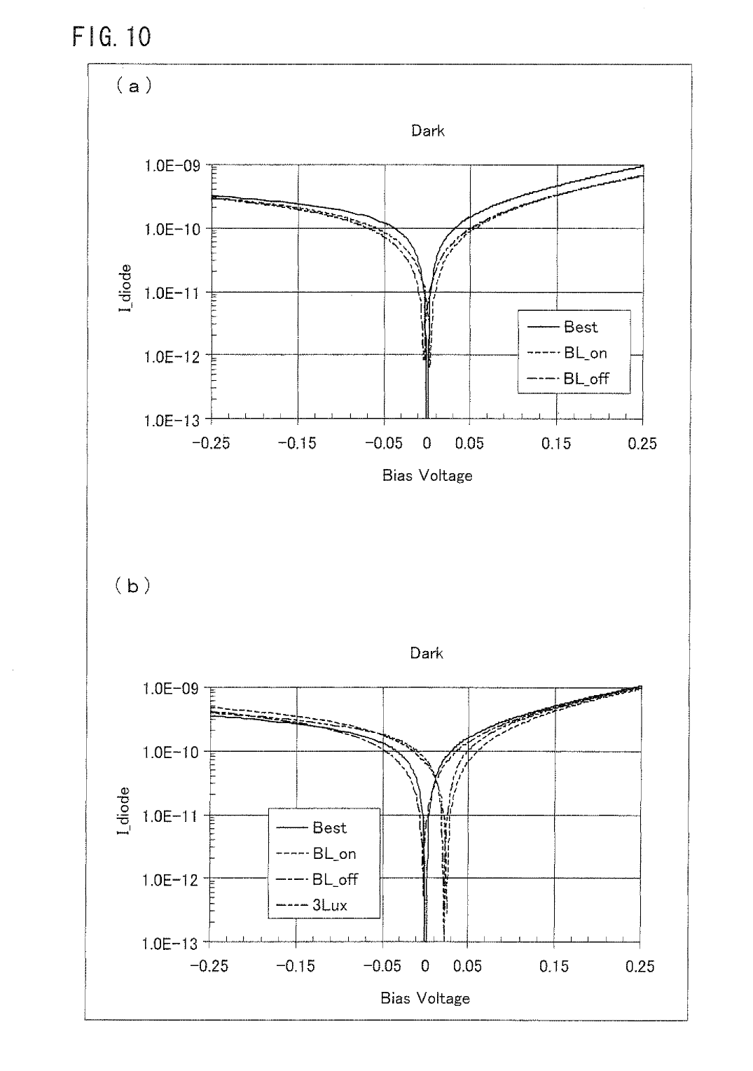

(a) and (b) of FIG. 10 are graphs which illustrate results of measuring, in the liquid crystal display device of FIG. 9, I-V characteristics of diodes constituting the respective light sensors. (a) of FIG. 10 is the result for a reference light sensor, and (b) of FIG. 10 is the result for a detection light sensor.

### REFERENCE SIGNS LIST

1 Liquid crystal display device
1′ Liquid crystal display device
10 Liquid crystal display panel
11 Active matrix substrate
12 Counter substrate
13 Liquid crystal layer
16 Light sensor
16a Detection light sensor (Light sensor)
16b Reference light sensor (Light sensor)
17 Light blocking section
18 Black matrix (Light blocking layer)
18a Opening
20 Backlight
33 Pixel electrode
33a Transparent conductive layer
62 Counter electrode
62a Counter electrode
62b Counter electrode
81 Voltage application section
101 Liquid crystal display device
R1 Image display region
R2 Peripheral region

### DESCRIPTION OF EMBODIMENTS

### First Embodiment

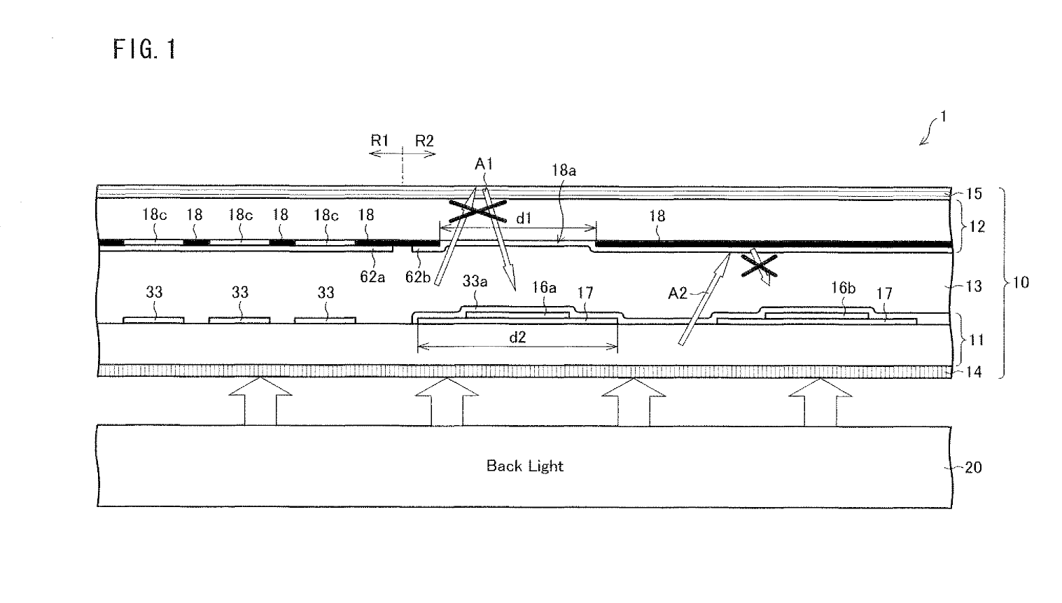

An embodiment of the present invention is described below with reference to FIGS. 1 through 7. Note that the present invention is not limited to this.

The present embodiment is exemplified by a liquid crystal display device which is used as a display section of a portable mobile terminal such as a mobile phone. Note that the present embodiment describes a liquid crystal display device including a normally black liquid crystal display panel in which black display is carried out under a state in which no electric potential difference is generated between an active matrix substrate and a counter substrate.

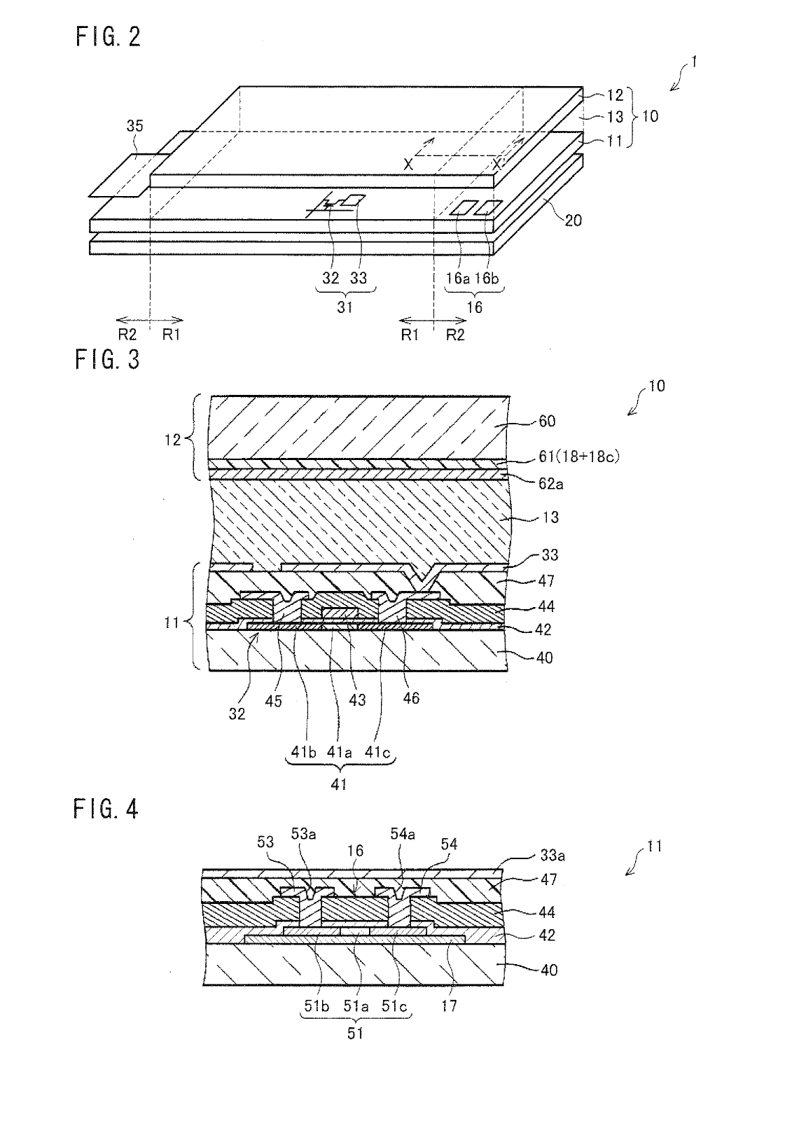

FIG. 2 illustrates an entire arrangement of a liquid crystal display device 1 according to an embodiment of the present invention. The liquid crystal display device 1 includes a liquid crystal display panel 10 and a backlight 20 provided on a rear side of the liquid crystal display 10. The liquid crystal display panel 10 includes an active matrix substrate 11 on which a large number of pixels 31 are provided in a matrix pattern, a counter substrate 12 which is provided to face the active matrix substrate 11, and a liquid crystal layer 13, serving as a display medium, which is sandwiched between the active matrix substrate 11 and the counter substrate 12.

A rear side polarizing plate 14 and a front side polarizing plate 15 (not illustrated in FIG. 2) are provided outside the active matrix substrate 11 and the counter substrate 12, respectively. According to the present embodiment, (i) use of a negative liquid crystal as a liquid crystal material causes a vertical alignment of liquid crystal molecules and (ii) the two polarizing plates 14 and 15 are provided so as to be in a crossed Nicols relationship. This causes the liquid crystal display panel 10 to be in the normally black mode.

Each of the large number of pixels 31 on the active matrix substrate 11 includes a thin film transistor (TFT) 32 for driving a liquid crystal serving as a display medium, a pixel electrode 33, and the like. A counter electrode 62 (not illustrated in FIG. 2) and a color filter layer 61 (not illustrated in FIG. 2) are provided on the counter substrate 12. As described later, the color filter layer 61 includes (i) colored sections 18c whose colors are red (R), green (G), and blue (B) and (ii) a black matrix (light blocking layer) 18.

The active matrix substrate 11 has a region (display region) R1 in which the large number of pixels 31 are provided and a peripheral region (non-display region) R2 which is adjacent to the display region. The counter substrate 12 is provided so that the peripheral region R2 is partially exposed (see FIG. 2).

An FPC 35 for connecting an external drive circuit to the liquid crystal display device 1 is mounted on the peripheral region R2 thus partially exposed, via a terminal (not illustrated). Moreover, a light sensor 16 for detecting an external brightness (a brightness of an environment in which the liquid crystal display device 1 is used) is provided in the peripheral region R2 in which the counter substrate 12 is provided. Further, according to the present embodiment, the light sensor 16 includes two light sensors: (i) a detection light sensor 16a for detecting external light, and (ii) a reference light sensor 16b for correction. However, the present invention is not limited to the arrangement, provided that at least one detection light sensor is provided.

Note that at least the following components are provided in the peripheral region R2: (i) a drive circuit for driving the large number of pixels 31 provided in the display region R1, (ii) wires which are connected to the light sensor 16 and to the drive circuit, and (iii) wires drawn from the respective pixel electrodes ((i) through (iii) are not illustrated).

The TFTs 32 provided in the display region R1 and the light sensor 16 provided in the peripheral region R2 are monolithically formed on the active matrix substrate 11 by respective substantially the same processes. Namely, some components of the light sensor 16 and some components of each of the TFTs 32 are simultaneously formed.

The following describes a more specific arrangement of the light sensor 16 provided in the peripheral region R2 of the active matrix substrate 11 with reference to FIG. 1. FIG. 1 is a cross-sectional view taken on line X-X′ of the liquid crystal display device 1 shown in FIG. 2.

The two light sensors 16 (16a and 16b) are provided in the peripheral region R2 of the active matrix substrate 11 so as to detect a brightness of the environment in which the liquid crystal display device 1 is used (see FIG. 1). Moreover, the peripheral region R2 is the non-display region in which no image is displayed. Thus, the black matrix (light blocking layer) 18 is provided in a part of the counter substrate 12 which part corresponds to the color filter layer (see FIG. 1).

The two light sensors are: (i) the detection light sensor 16a and (ii) the reference light sensor 16b. The detection light sensor 16a is provided so as to detect a brightness of the environment in which the liquid crystal display device 1 is used. Thus, an opening 18a via which external light enters is provided in a part of the black matrix 18 which part corresponds to the light sensor 16a. On the other hand, the light sensor 16b serves as a correction sensor for at least carrying out a temperature compensation. As such, a region above the light sensor 16b is light-blocked by the black matrix 18.

An object of the light sensor 16 is to detect external light. When light emitted from the backlight 20 enters the light sensor 16, there occurs a problem that the light sensor 16 improperly operates. For this reason, a light blocking section 17 made of A1 or the like is provided under the light sensor 16 (i.e., between the backlight 20 and the light sensor 16). An area d2 of the light blocking section 17 is larger than an area d1 of the opening 18a. This allows a more secure prevention of the light sensor 16 from detecting light emitted from the backlight 20.

Further, a transparent conductive layer 33a is provided on the active matrix substrate 11 so as to cover the light sensors 16a and 16b. It is possible to form the transparent conductive layer 33a and the pixel electrodes 33 by a single process and by use of a single material (e.g. ITO, IZO, or the like).

Note in the step of forming each of these members that it is preferable to carry out patterning with respect to the transparent conductive layer 33a so that: the transparent conductive layer 33a is electrically isolated from the pixel electrodes 33 provided in the display region R1; and the transparent conductive layer 33a provided in the peripheral region R2 is connected to a fixed electric potential (e.g. 0V). This causes the transparent conductive layer 33a to serve as an electromagnetic shield for (i) the light sensor 16 covered by the transparent conductive layer 33a and (ii) other peripheral circuits provided in the peripheral region R2. This allows an improvement in resistance to an electromagnetic noise and an S/N ratio of the light sensor 16, and it is thus possible for the light sensor 16 to sense light with higher accuracy. Moreover, it is possible to prevent the peripheral circuits from improperly operating.

Further, the liquid crystal display device 1 of the present embodiment is arranged such that a counter electrode 62b which is provided on the counter substrate 12 in the peripheral region R2 is separated from a counter electrode 62a which is provided on the counter substrate 12 in the display region R1. According to the arrangement, it is possible to apply, to the counter electrode 62b, a different voltage from a voltage applied to the counter electrode 62a. For example, it is possible to apply, to the counter electrode 62b, the same fixed potential as the fixed potential (e.g. 0V) of the transparent conductive layer 33a.

Furthermore, as described later, the transparent conductive layer 33a provided on the light sensor 16 and the counter electrode 62b provided to face the transparent conductive layer 33a are connected to a voltage application section 81 for applying respective given voltages to the transparent conductive layer 33a and the counter electrode 62b, as described later. This allows an electric potential difference between the transparent conductive layer 33a and the counter electrode 62 to be set to a desired value.

The following describes a more specific arrangement of each of the large number of pixels 31 provided in the display region R1 of the liquid crystal display device 1 of the present embodiment with reference to FIG. 3. FIG. 3 is a partial cross-sectional view of the liquid crystal display panel 10.

The liquid crystal display panel 10 is arranged such that the liquid crystal layer 13 is provided between the active matrix substrate 11 and the counter substrate 12 (see FIG. 3). The active matrix substrate 11 is provided with the TFTs 32 for driving the liquid crystal, and the pixel electrodes 33. A structure of each of the TFTs 32 is referred to as “top gate structure” or “staggered structure”. Each of the TFTs 32 includes a gate electrode provided above a semiconductor film (polycrystalline Si film) 41 serving as a channel.

Each of the TFTs 32 includes: (i) the polycrystalline Si film 41 provided on a glass substrate 40 serving as a base material, (ii) a gate insulating film 42 (e.g. an oxide silicon film, a silicon nitride film, or the like) provided so as to cover the polycrystalline Si film, (iii) a gate electrode 43 (made of Al, Mo, Ti, or an alloy thereof) provided on the gate insulating film, and (iv) a first interlayer insulating film 44 (e.g. an oxide silicon film, a silicon nitride film, or the like) provided so as to cover the gate electrode.

Note here that a region of the polycrystalline Si film 41 which region faces the gate electrode 43 via the gate insulating film 42 serves as a channel region 41a. Note also that two regions of the polycrystalline Si film 41 other than the channel region 41a are n+ layers to which an impurity is added with high concentration. The respective two regions serve as a source region 41b and a drain region 41c. Note also that respective LDD (Lightly Doped Drain) regions (not illustrated), to which an impurity is added with low concentration, are provided (i) in a region of the source region 41b closer to the channel region 41a and (ii) in a region of the drain region 41c closer to the channel region 41a so as to prevent degradation of an electric property caused by a hot carrier.

A source electrode 45 (made of Al, Mo, Ti, or an alloy thereof) provided on the first interlayer insulating film 44 is electrically connected to the source region 41b of the polycrystalline Si film 41, via a contact hole which penetrates through the first interlayer insulating film 44 and the gate insulating film 42. Similarly, a drain electrode 46 (made of Al, Mo, Ti, or an alloy thereof) provided on the first interlayer insulating film 44 is electrically connected to the drain region 41c of the polycrystalline Si film 41, via a contact hole which penetrates through the first interlayer insulating film 44 and the gate insulating film 42.

The above describes a basic structure of each of the TFTs 32. In the display region R1, a second interlayer insulating film 47 is further provided so as to cover the TFTs 32. Furthermore, the pixel electrodes 33, each of which is made of ITO (Indium-Tin-Oxide), IZO (Indium-Zinc-Oxide) or the like, are provided on the second interlayer insulating film 47. The pixel electrodes 33 are electrically connected to the drain electrodes 46, via respective contact holes provided in the second interlayer insulating film 47.

On the other hand, the counter substrate 12 has a structure in which the color filter layer 61 and the counter electrode 62a are stacked in this order on a glass substrate 60 serving as a base material. The color filter layer 61 is constituted by the black matrix 18 and the colored sections 18c. An electric potential difference is generated between the counter electrode 62a and the respective pixel electrodes 33 provided on the active matrix substrate 11. This causes a change in transmittance of each of the large number of pixels.

The following describes a more specific arrangement of the light sensor 16 provided in the peripheral region R2 of the liquid crystal display device 1 in accordance with the present embodiment with reference to FIG. 4. FIG. 4 is a partial cross-sectional view of the active matrix substrate 11.

The light sensor 16 in the present embodiment is referred to as “a photodiode having a lateral structure”, and includes a diode in which a PIN junction of a semiconductor is provided in a surface direction (a lateral direction) of the substrate.

The light sensor 16 is provided in the peripheral region R2 of the active matrix substrate 11. The light blocking section 17 made of A1 or the like is provided on the glass substrate 40 serving as a base material, and the light sensor 16 is provided on this light blocking section 17 (see FIG. 4). The light sensor 16 is constituted by a PIN diode made of a polycrystalline Si film 51. The polycrystalline Si film 51 is formed by the same process and at the same time as the polycrystalline Si film 41 which constitutes the TFTs 32 provided in the display region R1. Therefore, the polycrystalline Si films 41 and 51 have an identical thickness.

The PIN junction includes a p+ layer (a region 51b) and an n+ layer (a region 51c) to which respective impurities are added with high concentration, and an i layer (a region 51a) to which no impurity is added. Note that it is possible to use a p− layer and/or an n− layer to which impurities are added with low concentration, instead of the i layer.

Further, the gate insulating film 42 and the first interlayer insulating film 44 are provided so as to cover the polycrystalline Si film 51 having the PIN junction. The gate insulating film 42 and the first interlayer insulating film 44 which are illustrated in FIG. 4 are respectively the gate insulating film 42 and the first interlayer insulating film 44 of the TFTs 32 provided in the display region R1 (see FIG. 3) which extend to the peripheral region R2.

A p-side electrode 53 (made of Al, Mo, Ti, or an alloy thereof) provided on the first interlayer insulating film 44 is electrically connected to the p+ region 51b of the polycrystalline Si film 51, via a contact hole which penetrates through the first interlayer insulating film 44 and the gate insulating film 42. Similarly, an n-side electrode 54 (made of Al, Mo, Ti, or an alloy thereof) provided on the first interlayer insulating film 44 is electrically connected to the n region 51c of the polycrystalline Si film 51, via a contact hole which penetrates through the first interlayer insulating film 44 and the gate insulating film 42. Parts of the p-side electrode 53 and the n-side electrode 54 which parts are exposed in a top surface of the first interlayer insulating film 44 are respective electrode sections of the light sensor 16.

Note that the contact holes, which are provided in the peripheral region R2 so as to penetrate through the first interlayer insulating film 44 and the gate insulating film 42, are formed by the same process and at the same time as the contact holes which are provided in the display region R1 so as to penetrate through the first interlayer insulating film 44 and the gate insulating film 42. Note also that the p-side electrode 53 and the n-side electrode 54 are formed by the same process and at the same time as the source electrodes 45 and the drain electrodes 46 which are provided in the respective TFTs 32.

The above describes a basic structure of the light sensor 16. The light sensor 16 and the TFTs 32 provided in the display region R1 are basically constituted by identical components, and also have an identical manufacturing process. This allows a monolithic formation, on the active matrix substrate 11, of the TFTs 32 provided in the display region R1 and the light sensor 16 provided in the peripheral region R2.

Note that at least the following components are provided in the peripheral region R2: (i) a drive circuit for driving the large number of pixels 31 provided in the display region R1, (ii) wires which are connected to the light sensor 16 and to the drive circuit, and (iii) wires drawn from the respective pixel electrodes.

Moreover, the second interlayer insulating film 47 in the display region R1 extends to the peripheral region R2 so as to be provided on the light sensor 16, the drive circuits, and the wires in the peripheral region R2 (see FIG. 4).

The transparent conductive layer 33a is further provided on the second interlayer insulating film 47. It is possible to form the transparent conductive layer 33a by use of (i) an oxide conductive film made of a material such as ITO, IZO, Zno, or SnO₂ or (ii) a coat-type electrode material in which particles of such a material are dispersed. Note that it is possible to form, during a single step, the transparent conductive layer 33a and the pixel electrodes 33 provided in the display region R1, in a case where the pixel electrodes 33 and the transparent conductive layer 33a are formed, by use of an identical material.

According to the arrangement illustrated in FIG. 4, top parts of the p-side electrode 53 and the n-side electrode 54 are provided with recessed parts 53a and 54a, respectively, for their better adhesion to the second interlayer insulating film 47. Note however that it is not always necessary to provide the recessed parts.

The following describes a method for driving the liquid crystal display device 1 of the present embodiment. The display mode of the liquid crystal display panel 10 included in the liquid crystal display device 1 is the normally black mode. According to the liquid crystal display device 1, a driving is carried out in which an electric potential of at least one of the transparent conductive layer 33a and the counter electrode 62b is set so that no electric potential difference is generated between the transparent conductive layer 33a provided on the light sensor 16 and the counter electrode 62b provided on the counter substrate 12 facing the transparent conductive layer 33a while the light sensor 16a is detecting an external brightness of the liquid crystal display device 1. The following specifically describes the method.

As described earlier, the liquid crystal display device 1 of the present embodiment is arranged such that the transparent conductive layer 33a provided on the light sensor and the counter electrode 62b provided to face the transparent conductive layer 33a are connected to a voltage application section 81 for applying respective given voltages to the transparent conductive layer 33a and the counter electrode 62b. This allows an electric potential difference between the transparent conductive layer 33a and the counter electrode 62 to be set to a desired value.

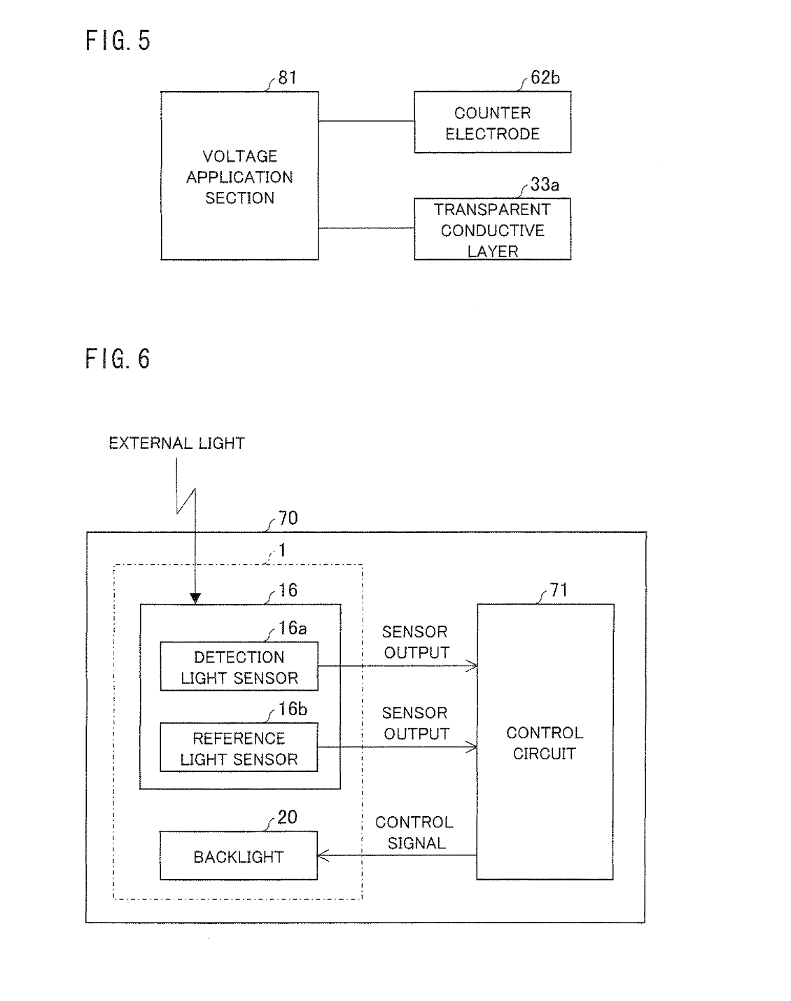

FIG. 5 illustrates how a voltage is applied to the light sensor 16 in the liquid crystal display panel 10. The liquid crystal display device 1 of the present embodiment includes the voltage application section 81 for applying respective voltages to the counter electrode 62b and the transparent conductive layer 33a which are provided in the peripheral region R2 (see FIG. 5). It is possible to form the voltage application section 81 as a part of various drive circuits provided in the peripheral region R2 of the liquid crystal display panel 10, for example. However, the present invention is not limited to such an arrangement.

The display mode of the liquid crystal display panel 10 of the present embodiment is the normally black mode. Therefore, the voltage application section 81 applies a voltage to at least one of the transparent conductive layer 33a and the counter electrode 62b so that no potential difference is generated between the transparent conductive layer 33a provided on the light sensor 16a and the counter electrode 62b provided in the peripheral region R2.

According to the arrangement, it is possible to cause a region in which the light sensor 16a is provided to be in the same state as a black display state, namely, it is possible to cause the liquid crystal display panel 10, in the region in which the light sensor 16a is provided, to have a transmittance obtained during the black display (or a transmittance not more than that transmittance). This causes a reduction, on the periphery of the light sensor 16a, in amount of stray light due to the light emitted from the backlight 20 (specifically, the light emitted from the backlight 20 is reflected from the front side polarizing plate 15 (see A1 of FIG. 1), and the light thus reflected becomes the stray light.). Therefore, it is possible to prevent the light sensor 16a from detecting the stray light, thereby ultimately preventing an error from being in a detected value. It follows that it is possible to solve the problem that the brightness of an external environment can not be accurately detected because the light sensor detects the stray light due to the light emitted from the backlight. Note that the black matrix 18, which is provided above the reference light sensor 16b, absorbs stray light A2 emitted from the backlight 20.

According to the liquid crystal display device 1 of the present embodiment, the counter electrode 62a provided in the image display region R1 and the counter electrode 62b provided in the peripheral region R2 are separately formed in the step of patterning a counter electrode. For this reason, it is possible for the voltage application section 81 to apply an identical fixed potential (e.g. 0 V) to each of the transparent conductive layer 33a and the counter electrode 62b so that the transparent conductive layer 33a serves as the electromagnetic shield.

Since the counter electrode 62a provided in the image display region R1 and the counter electrode 62b provided in the peripheral region R2 are separately provided, it is possible to apply a desired voltage to the counter electrode 62b, irrespective of a voltage to be applied to the counter electrode 62a. For this reason, even in a case a voltage which is necessary for the transparent conductive layer 33a to serve as the electromagnetic shield is applied to the transparent conductive layer 33a, it is possible to apply to the counter electrode 62b the same voltage as the voltage applied to the transparent conductive layer 33a. This brings about two effects of electromagnetic shielding and a reduction in stray light.

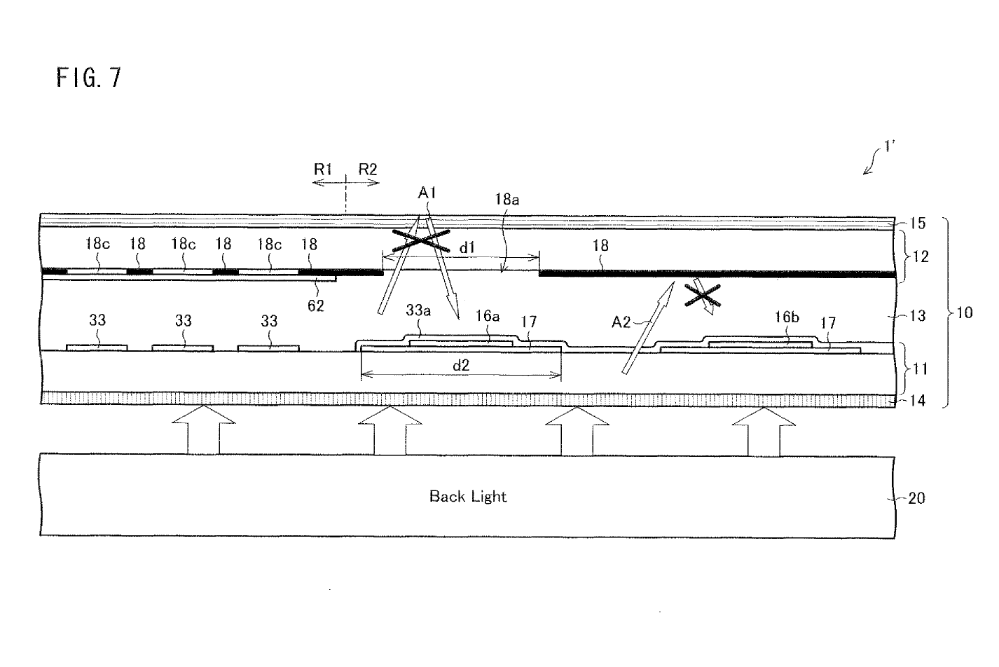

However, the present invention is not limited to the arrangement. For example, FIG. 7 exemplifies an alternative arrangement of the liquid crystal display device of the present embodiment.

According to a liquid crystal display device 1′, a counter electrode 62 is provided only in an image display region R1 of a counter substrate 12. Namely, no counter electrode is provided in a peripheral region R2 of the liquid crystal display device 1′.

It is possible to carry out such patterning of a counter electrode in the step of forming the counter electrode 62 by etching or the like and removing a layer of the counter electrode which layer is in the peripheral region R2 in which the light sensor 16 is provided.

According to the arrangement, it is possible to realize a state in which no electric potential difference is generated between the light sensor and the counter substrate, irrespective of a voltage to be applied to a transparent conductive layer 33a on the light sensor. This does not necessarily require a voltage application section. As such, it is possible to cause a display state above the light sensor to be identical to a black display state while the light sensor is detecting an external brightness. It is thus possible to reduce stray light A1 reflected from an uppermost surface of a liquid crystal display panel.

As described earlier, the normally black liquid crystal display panel of the present invention is preferably arranged such that the counter electrode provided in the peripheral region R2 is separated from the counter electrode provided in the pixel display region R1 or no counter electrode is provided in the peripheral region R2. This allows a free determination of a fixed electric potential of the transparent conductive layer 33a.

Note however that the present invention is not necessarily limited to such an arrangement. Alternatively, the counter electrode can be arranged to be uniformly provided on the counter substrate (namely, the counter electrode is not separated by a boundary between the image display region R1 and the peripheral region R2). In such a case, it is possible to cause an electric potential difference between the light sensor and the counter substrate to be 0 by changing, in accordance with an electric potential of the counter electrode, a voltage to be supplied to the transparent conductive layer 33a. This allows a transmittance of light emitted from the backlight in the region in which the light sensor is provided to be not more than a transmittance obtained during black display.

The liquid crystal display device 1 of the present embodiment is applicable to a display system with an automatic light control function in which display system a display luminance is automatically controlled in accordance with a brightness (illuminance) of an environment in which the display system is used, the brightness being detected by use of the light sensor 16. Namely, it is possible to automatically control a display luminance of the liquid crystal display device 1, by providing a control circuit for controlling a luminance of the backlight 20 in accordance with information on a brightness of external light, the information being supplied from the light sensor 16 provided in the peripheral region R2 of the active matrix substrate 11. This allows an automatic luminance adjustment in which: a display luminance is increased under a bright environment such as outdoors in the daytime; and a display luminance is decreased under a comparatively dark environment such as nighttime or indoors. This ultimately allows the liquid crystal display device 1 to realize a reduction in power consumption and a life extension.

FIG. 6 illustrates, as an example of such a display system, a schematic arrangement of an electronic device 70 including the liquid crystal display device 1 of the present embodiment. The electronic device 70 includes the liquid crystal display device 1 and a control circuit 71 (control section) which controls a display luminance of the liquid crystal display device 1 in accordance with information on a brightness of external light which brightness is detected by a light sensor 16 (specifically, the detection sensor 16a and the reference sensor 16b) provided in the liquid crystal display device 1 (see FIG. 6).

The control circuit 71 controls a display luminance of the liquid crystal display device 1 by adjusting a luminance of the backlight 20 in accordance with information (sensor output) on a brightness of external light which brightness is detected by the light sensor 16. For example, it is possible to automatically adjust a luminance such that: a display luminance is increased under a bright environment such as outdoors; and a display luminance is decreased under a comparatively dark environment such as nighttime or indoors. This ultimately allows the liquid crystal display device 1 to realize a reduction in power consumption and a life extension.

The electronic device 70 thus allows a realization of both good visibility and low power consumption even in a case where there occurs a change in brightness of an environment in which the electronic device is used. Therefore, such an electronic device has a number of occasions to be taken outside for use. Such an electronic device is useful particularly for a mobile device which needs to be battery-powered (e.g. a mobile phone, an information terminal such as a PDA, a mobile game device, a portable music player, a digital camera, and the like).

### Second Embodiment

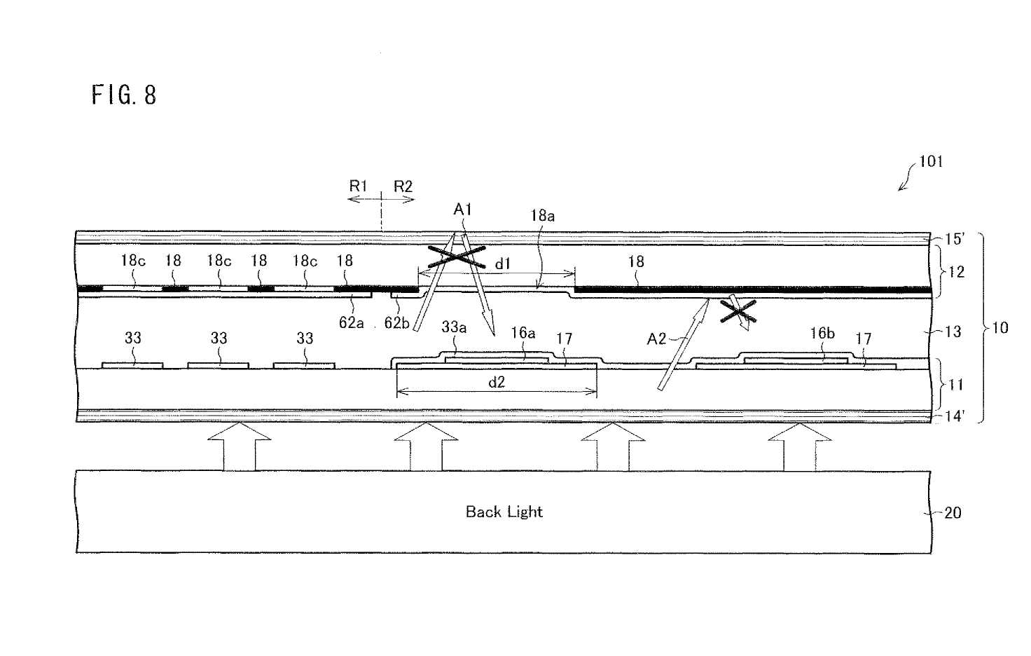

The following describes a second embodiment of the present invention with reference to FIG. 8.

The present embodiment describes a liquid crystal display device including a normally white liquid crystal display panel in which white display is carried out in a state in which no electric potential difference is generated between the active matrix substrate and the counter electrode. Note that a description of a similar arrangement to the first embodiment is to be omitted, and only a point of difference from the first embodiment is to be described.

An entire arrangement of a liquid crystal display device 101 in accordance with the present embodiment is substantially identical to the arrangement of the liquid crystal display device 1 illustrated in FIG. 2, except for an arrangement of a rear side polarizing plate 14′ and a front side polarizing plate 15′ which are provided outside the active matrix substrate 11 and the counter substrate 12, respectively. According to the present embodiment, the two polarizing plates 14′ and 15′ are provided so as to be in a parallel Nicols relationship. This causes the liquid crystal display panel 10 to be in the normally white mode.

FIG. 8 is a partial cross-sectional view of the liquid crystal display device 101.

The two light sensors 16 (16a and 16b) are provided in the peripheral region R2 of the active matrix substrate 11 so as to detect a brightness of an environment in which the liquid crystal display device 101 is used (see FIG. 8). Moreover, the peripheral region R2 is the non-display region in which no image is displayed. Thus, the black matrix (light blocking layer) 18 is provided in a part of the counter substrate 12 which part corresponds to the color filter layer (see FIG. 8).

The two light sensors are: (i) the detection light sensor 16a and (ii) the reference light sensor 16b. The detection light sensor 16a is provided so as to detect a brightness of the environment in which the liquid crystal display device 101 is used. Thus, the opening 18a via which external light enters is provided in a part of the black matrix 18 which part corresponds to the light sensor 16a. On the other hand, the light sensor 16b serves as a correction sensor for at least carrying out a temperature compensation. As such, a region above the light sensor 16b is light-blocked by the black matrix 18.

Note that the liquid crystal display device 101 and the liquid crystal display device 1 of the first embodiment have an identical cross-sectional arrangement, except that the rear side polarizing plate 14′ and the front side polarizing plate 15′ are provided so as to be in the parallel Nicols relationship. For this reason, a more specific description of the arrangement of the present embodiment is to be omitted.

The following describes a method for driving the liquid crystal display device 101 of the present embodiment. The display mode of the liquid crystal display panel 10 included in the liquid crystal display device 101 is the normally white mode. According to the liquid crystal display device 101, a driving is carried out in which an electric potential of at least one of the transparent conductive layer 33a and the counter electrode 62b is set so that an electric potential difference between the transparent conductive layer 33a provided on the light sensor 16 and the counter electrode 62b provided on the counter substrate 12 facing the transparent conductive layer 33a is identical to an electric potential difference generated during black display in the image display region R1 of the liquid crystal display panel 10, while the light sensor 16a is detecting an external brightness of the liquid crystal display device 101. The following specifically describes the method.

The liquid crystal display device 101 of the present embodiment is arranged such that the transparent conductive layer 33a provided on the light sensor 16 and the counter electrode 62b provided to face the transparent conductive layer 33a are connected to a voltage application section 81 for applying respective given voltages to the transparent conductive layer 33a and the counter electrode 62b (see FIG. 5). This allows an electric potential difference between the transparent conductive layer 33a and the counter electrode 62 to be set to a desired value.

The liquid crystal display device 101 of the present embodiment includes the voltage application section 81 for applying respective voltages to the counter electrode 62b and the transparent conductive layer 33a which are provided in the peripheral region R2 (see FIG. 5). It is possible to form the voltage application section 81 as a part of various drive circuits provided in the peripheral region R2 of the liquid crystal display panel 10, for example.

The display mode of the liquid crystal display panel 10 of the present embodiment is the normally white mode. Therefore, the voltage application section 81 applies a voltage to at least one of the transparent conductive layer 33a and the counter electrode 62b so that an electric potential difference between the transparent conductive layer 33a provided on the light sensor 16 and the counter electrode 62b provided in the peripheral region R2 is identical to an electric potential difference generated during black display in the image display region R1 of the liquid crystal display panel 10.

According to the arrangement, it is possible to cause a region in which the light sensor 16a is provided to be in the same state as a black display state, namely, it is possible to cause the liquid crystal display panel 10, in the region in which the light sensor 16a is provided, to have a transmittance obtained during the black display (or a transmittance not more than that transmittance). This causes a reduction, on the periphery of the light sensor 16a, in amount of stray light due to the light emitted from the backlight 20 (specifically, the light emitted from the backlight 20 is reflected from the front side polarizing plate 15′ (see A1 of FIG. 8), and the light thus reflected becomes the stray light.). Therefore, it is possible to prevent the light sensor 16a from detecting the stray light, thereby ultimately preventing an error from being in a detected value. It follows that it is possible to solve the problem that the brightness of an external environment can not be accurately detected because the light sensor detects the stray light due to the light emitted from the backlight. Note that the black matrix 18, which is provided above the reference light sensor 16b, absorbs stray light A2 emitted from the backlight 20.

Such a normally white liquid crystal display panel as the present embodiment is preferably arranged such that the counter electrode provided in the peripheral region R2 is separated from the counter electrode provided in the pixel display region R1 (see FIG. 8). This allows a free determination of a fixed electric potential of the transparent conductive layer 33a. Note, in this case, that application of a given voltage to the counter electrode 62b in accordance with the fixed potential by the voltage application section 81 allows an electric potential difference which is identical to an electric potential difference generated during black display to be generated between the transparent conductive layer 33a and the counter electrode 62b.

Note however that the present invention is not necessarily limited to such an arrangement. Alternatively, the counter electrode can be arranged to be uniformly provided on the counter substrate (namely, the counter electrode is not separated by a boundary between the image display region R1 and the peripheral region R2). In such a case, it is possible to cause an electric potential difference between the light sensor and the counter substrate to be identical to an electric potential difference generated during black display by changing, in accordance with an electric potential of the counter electrode, a voltage to be supplied to the transparent conductive layer 33a. This allows a transmittance of light emitted from the backlight in the region in which the light sensor is provided to be not more than a transmittance obtained during black display.

The present invention is not limited to the description of the embodiments above, but may be altered by a skilled person within the scope of the claims. An embodiment based on a proper combination of technical means disclosed in different embodiments is encompassed in the technical scope of the present invention.

As described earlier, a liquid crystal display device of the present invention is arranged such that: a light sensor for detecting an external brightness of the liquid crystal display device is provided in a peripheral region which is on a periphery of an image display region of the liquid crystal display panel, and light emitted from the backlight has a transmittance of not more than a transmittance obtained during black display in the region in which the light sensor is provided, while the light sensor is detecting an external brightness of the liquid crystal display device.

According to the arrangement, it is possible to prevent the light sensor from improperly detecting stray light due to light emitted from the backlight. It follows that it is possible to solve the problem that the brightness of an external environment can not be accurately detected because the light sensor detects the stray light due to the light emitted from the backlight.

As described earlier, a method for driving a liquid crystal display device of the present invention is such that an electric potential difference is set between the light sensor and the counter substrate so that light emitted from the backlight has a transmittance of not more than a transmittance obtained during black display in the region in which the light sensor is provided, while the light sensor is detecting a brightness of external light.

According to the method, it is possible to prevent the light sensor from improperly detecting stray light due to light emitted from the backlight. It follows that it is possible to solve the problem that the brightness of an external environment can not be accurately detected because the light sensor detects the stray light due to the light emitted from the backlight.

As described earlier, the present invention makes it possible to provide a liquid crystal display device including a light sensor which is less affected by stray light and is capable of detecting an external brightness with higher accuracy.

The embodiments and concrete examples of implementation discussed in the aforementioned detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The invention is applicable to a liquid crystal display device including a light sensor which detects an external brightness. The present invention allows the light sensor to detect an external brightness with high accuracy.

1. A liquid crystal display device comprising:
a liquid crystal display panel in which a liquid crystal layer is provided between an active matrix substrate and a counter substrate;
a backlight which emits light toward the liquid crystal display panel, and
a light sensor provided, in a peripheral region which is on a periphery of an image display region of the liquid crystal display panel, for detecting an external brightness of the liquid crystal display device,
light emitted from the backlight having a transmittance of not more than a transmittance obtained during black display in the peripheral region in which the light sensor is provided, while the light sensor is detecting an external brightness of the liquid crystal display device.

2. The liquid crystal display device as set forth in claim 1, wherein:
a display mode of the liquid crystal display panel is a normally black mode,
said liquid crystal display device further comprising:
a voltage application section for applying a voltage to at least one of the light sensor and the counter substrate so that no electric potential difference is generated between the light sensor and the counter substrate, while the light sensor is detecting the external brightness of the liquid crystal display device.

3. The liquid crystal display device as set forth in claim 2, wherein:
the counter substrate is provided with a counter electrode for causing an electric potential difference to be generated between the counter electrode and a pixel electrode provided on the active matrix substrate;
the counter electrode is separated by a boundary between the image display region and the peripheral region; and
the voltage application section applies a voltage to the counter electrode provided on the peripheral region.

4. The liquid crystal display device as set forth in claim 1, wherein:
a display mode of the liquid crystal display panel is a normally black mode;
the counter substrate is provided with a counter electrode for causing an electric potential difference to be generated between the counter electrode and a pixel electrode provided on the active matrix substrate; and
no counter electrode is provided at least in a part of the peripheral region, which part faces a part where the light sensor is provided.

5. The liquid crystal display device as set forth in claim 1, wherein:
a display mode of the liquid crystal display panel is a normally white mode,
said liquid crystal display device further comprising:
a voltage application section for applying a voltage to at least one of the light sensor and the counter substrate so that an electric potential difference between the light sensor and the counter substrate is identical to an electric potential difference generated during black display in the image display region of the liquid crystal display panel, while the light sensor is detecting an external brightness of the liquid crystal display device.

6. The liquid crystal display device as set forth in claim 5, wherein:
the counter substrate is provided with a counter electrode for causing an electric potential difference to be generated between the counter electrode and a pixel electrode provided on the active matrix substrate;
the counter electrode is separated by a boundary between the image display region and the peripheral region; and
the voltage application section applies a voltage to the counter electrode provided on the peripheral region.

7. The liquid crystal display device as set forth in claim 1, further comprising:
a light blocking layer, provided in the peripheral region of the counter substrate, for blocking light emitted from the backlight,
the light blocking layer having an opening, provided so as to face the light sensor, for detecting external light,
a light blocking section being provided between the light sensor and the backlight, and
the light blocking section having a surface whose area is larger than an area of the opening.

8. A method for driving a liquid crystal display device,
the liquid crystal display device including:
a liquid crystal display panel in which a liquid crystal layer is provided between an active matrix substrate and a counter substrate;
a backlight which emits light toward the liquid crystal display panel, and
a light sensor provided, in a peripheral region which is on a periphery of an image display region of the liquid crystal display panel, for detecting an external brightness of the liquid crystal display device,
said method comprising the step of:
setting an electric potential between the light sensor and the counter substrate so that light emitted from the backlight has a transmittance of not more than a transmittance obtained during black display in the peripheral region in which the light sensor is provided, while the light sensor is detecting an external brightness of the liquid crystal display device.

9. The method as set forth in claim 8, wherein:
a display mode of the liquid crystal display panel is a normally black mode; and
an electric potential of at least one of the light sensor and the counter substrate is set so that no electric potential difference is generated between the light sensor and the counter substrate, while the light sensor is detecting the external brightness of the liquid crystal display device.

10. The method as set forth in claim 8, wherein:
a display mode of the liquid crystal display panel is a normally white mode; and
an electric potential of at least one of the light sensor and the counter substrate is set so that an electric potential difference between the light sensor and the counter substrate is identical to an electric potential difference generated during black display in the image display region of the liquid crystal display panel, while the light sensor is detecting an external brightness of the liquid crystal display device.

11. A display system comprising:
a liquid crystal display device recited in claim 1; and
a control section for controlling a display luminance of the liquid crystal display device in accordance with information on a brightness of external light, the brightness being detected by the light sensor provided in the liquid crystal display device.
